(19) United States
(12) Patent Application Publication
(10) Pub. No.: US 2016/0234240 A1
(43) Pub. Date: Aug. 11, 2016

(54) RULES ENGINE FOR CONVERTING SYSTEM-RELATED CHARACTERISTICS AND EVENTS INTO CYBER-SECURITY RISK ASSESSMENT VALUES

(71) Applicant: Honeywell International Inc., Morris Plains, NJ (US)

(72) Inventors: Kenneth W. Dietrich, Glendale, AZ (US); Ganesh P. Gadhe, Pune (IN); Eric T. Boice, Mesa, AZ (US); Seth G. Carpenter, Phoenix, AZ (US)

(21) Appl. No.: 14/871,695

(22) Filed: Sep. 30, 2015

Related U.S. Application Data
(60) Provisional application No. 62/113,075, filed on Feb. 6, 2015.

(51) Int. Cl. H04L 29/06

(52) U.S. Cl. CPC H04L 63/1433

(57) ABSTRACT

This disclosure provides a rules engine for converting system-related characteristics and events into cyber-security risk assessment values, including related systems and methods. A method includes receiving information identifying characteristics of multiple devices in a computing system and multiple events associated with the multiple devices. The method includes analyzing the information using multiple sets of rules. The method includes generating at least one risk assessment value based on the analyzing. The at least one risk assessment value identifies at least one cyber-security risk of the multiple devices. The method includes displaying the at least one risk assessment value in a user interface.

### CROSS-REFERENCE TO RELATED APPLICATION

This application claims the benefit of the filing date of U.S. Provisional Patent Application 62/113,075, filed Feb. 6, 2015, which is hereby incorporated by reference.

### TECHNICAL FIELD

This disclosure relates generally to network security. More specifically, this disclosure relates to a rules engine for converting system-related characteristics and events into cyber-security risk assessment values.

### BACKGROUND

Processing facilities are often managed using industrial process control and automation systems. Conventional control and automation systems routinely include a variety of networked devices, such as servers, workstations, switches, routers, firewalls, safety systems, proprietary real-time controllers, and industrial field devices. Often times, this equipment comes from a number of different vendors. In industrial environments, cyber-security is of increasing concern, and unaddressed security vulnerabilities in any of these components could be exploited by attackers to disrupt operations or cause unsafe conditions in an industrial facility.

### SUMMARY

This disclosure provides a rules engine for converting system-related characteristics and events into cyber-security risk assessment values, including related systems and methods. A method includes receiving information identifying characteristics of multiple devices in a computing system and multiple events associated with the multiple devices. The method includes analyzing the information using multiple sets of rules. The method includes generating at least one risk assessment value based on the analyzing. The at least one risk assessment value identifies at least one cyber-security risk of the multiple devices. The method includes displaying the at least one risk assessment value in a user interface.

In some embodiments, the information is received from source data components that are associated with and collect data from the multiple devices. In some embodiments, the information is processed by a normalization component that formats the information to a common format according the type of the information. In some embodiments, the risk manager system also transmits cyber security risk information, corresponding to the analysis, to one or more target data components. In some embodiments, the risk manager system also converts cyber security risk information, corresponding to the analysis, into a format that can be processed by respective target data components. In some embodiments, the risk manager system also defines behaviors and applies the behaviors to the multiple sets of rules, the multiple sets of rules including at least one of time-based rules, cumulative rules, and impact rules. In some embodiments, the risk manager system also aggregates risk assessment values over a hierarchy of the multiple devices.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates an example rule handling infrastructure for identifying security issues in industrial process control and automation systems or other systems according to this disclosure; and

FIG. 3 illustrates a flowchart of a process in accordance with disclosed embodiments.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

In the following discussion, “SIEM” refers to “Security Information and Event Management,” which denotes technology that provides real-time analysis of security alerts in a system. Also, “SCOM” refers to the System Center Operations Manager infrastructure monitoring software tool available from MICROSOFT CORPORATION.

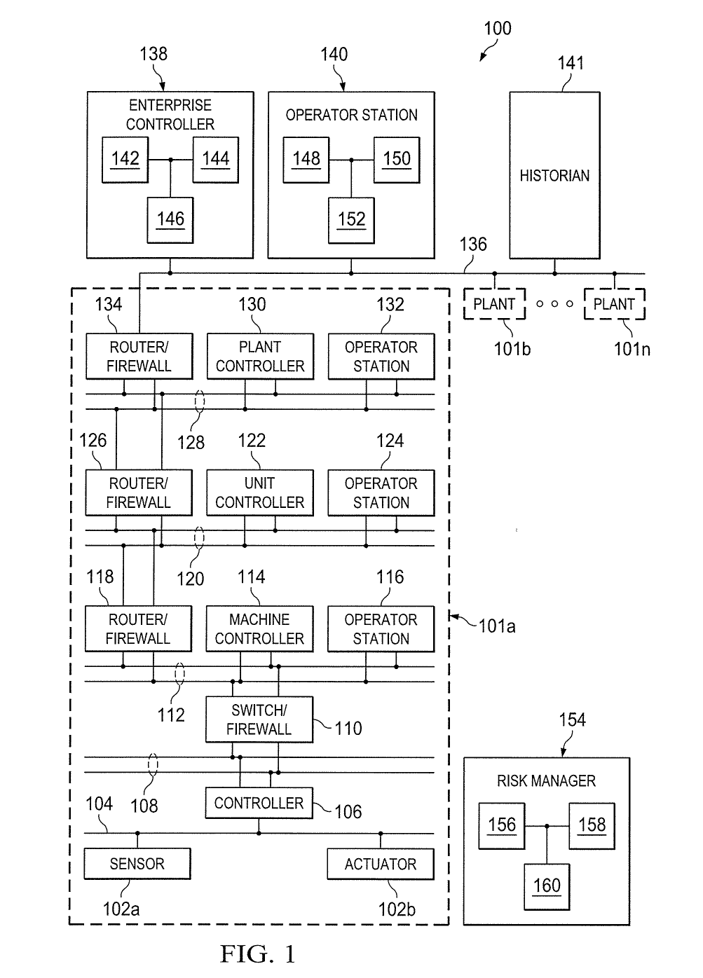

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Each controller 106 includes any suitable structure for interacting with one or more sensors 102a and controlling one or more actuators 102b. Each controller 106 could, for example, represent a proportional-integral-derivative (PID) controller or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers 106, 114, 122, 130, 138 could include one or more processing devices 142 and one or more memories 144 for storing instructions and data used, generated, or collected by the processing device(s) 142. Each of the controllers 106, 114, 122, 130, 138 could also include at least one network interface 146, such as one or more Ethernet interfaces or wireless transceivers. Also, each of the operator stations 116, 124, 132, 140 could include one or more processing devices 148 and one or more memories 150 for storing instructions and data used, generated, or collected by the processing device(s) 148. Each of the operator stations 116, 124, 132, 140 could also include at least one network interface 152, such as one or more Ethernet interfaces or wireless transceivers.

As noted above, cyber-security is of increasing concern with respect to industrial process control and automation systems. Unaddressed security vulnerabilities in any of the components in the system 100 could be exploited by attackers to disrupt operations or cause unsafe conditions in an industrial facility. However, in many instances, operators do not have a complete understanding or inventory of all equipment running at a particular industrial site. As a result, it is often difficult to quickly determine potential sources of risk to a control and automation system.

This disclosure recognizes a need for a solution that understands potential vulnerabilities in various systems, prioritizes the vulnerabilities based on risk to an overall system, and guides a user to mitigate the vulnerabilities. This is accomplished (among other ways) by using a “rule handling infrastructure,” which in the example in FIG. 1 is implemented or supported using a risk manager 154. The risk manager 154 includes any suitable structure that includes a rules engine for converting system-related characteristics and events into cyber-security risk assessment values. Here, the risk manager 154 includes one or more processing devices 156; one or more memories 158 for storing instructions and data used, generated, or collected by the processing device(s) 156; and at least one network interface 160. Each processing device 156 could represent a microprocessor, microcontroller, digital signal process, field programmable gate array, application specific integrated circuit, or discrete logic. Each memory 158 could represent a volatile or non-volatile storage and retrieval device, such as a random access memory or Flash memory. Each network interface 160 could represent an Ethernet interface, wireless transceiver, or other device facilitating external communication. The functionality of the risk manager 154 could be implemented using any suitable hardware or a combination of hardware and software/firmware instructions.

Although FIG. 1 illustrates one example of an industrial process control and automation system 100, various changes may be made to FIG. 1. For example, a control and automation system could include any number of sensors, actuators, controllers, servers, operator stations, networks, risk managers, and other components. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates an example environment in which the functions of the risk manager 154 can be used. This functionality can be used in any other suitable device or system.

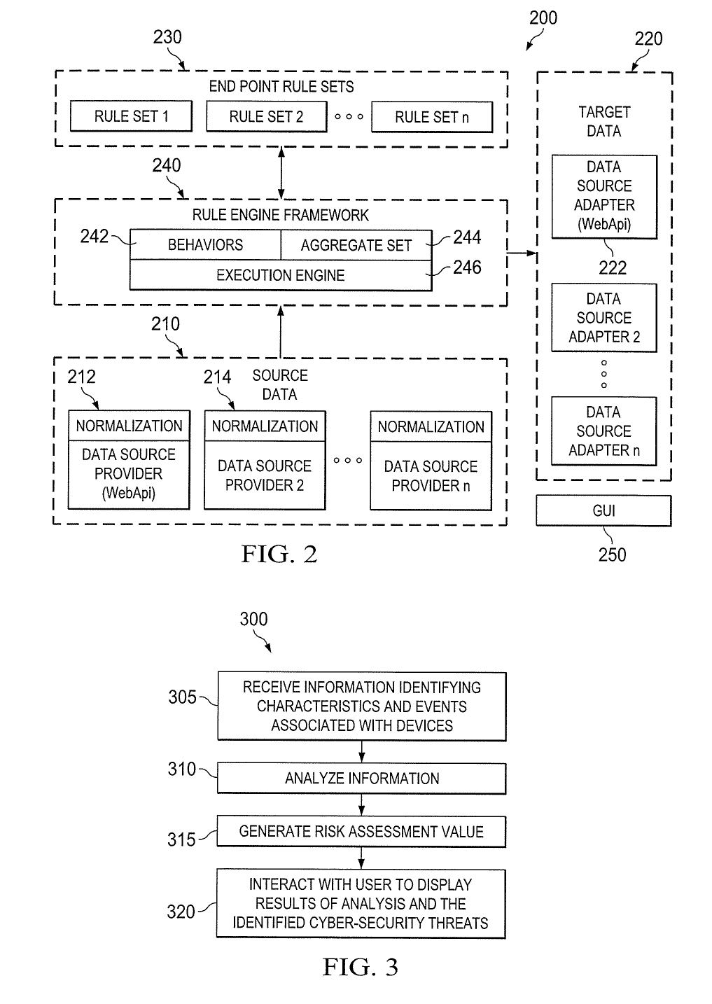

FIG. 2 illustrates an example rule handling infrastructure 200 for identifying security issues in industrial process control and automation systems according to this disclosure. The infrastructure 200 could be supported or implemented using the risk manager 154 or other processing device configured to perform as disclosed herein. This infrastructure 200 analyzes collected risk data and dynamically creates risk values based on rules for various risk items. Risk values are associated with devices in a computing system in which the risks occurred or exist.

Multiple risk values can be aggregated up into a hierarchy of devices to help identify areas that are more at risk. In various embodiments, the infrastructure 200 is configured so that a user is able to add and remove security products (such as MCAFEE or SYMANTEC products) without having to modify the rule infrastructure. Rule sets, in various embodiments, can be generic so that the same rules for similar types of products (such as antivirus products) can apply to any product of that product type without having to modify the rules.

In the example shown in FIG. 2, the rule handling infrastructure 200 includes logical components including source data components 210, target data components 220, end point rule sets 230, and a rule engine framework 240. The rule handling infrastructure 200 also includes a user interface (GUI) 250 for displaying information and interacting with users as described herein. GUI 250 can display data as produced by the rule handling infrastructure 200 via a device or application directly interfacing with rule engine framework 240, by a device or application that functions as or is connected to a target data component 220, or otherwise.

The source data components 210 include individual input processing units (data source providers 212) for incoming data. The incoming data can include information identifying characteristics of multiple devices in a computing system (such as the system 100) and multiple events associated with the multiple devices, each designated in FIG. 2 as a data source provider 212. The source data components 210 could, for example, be associated with and collect data from the various computing and networking components shown in FIG. 1. In different implementations, there may or may not be a theoretical limit to the number of data source providers that can be supported. There can, of course, be physical limits based on the hardware memory or processor speed that could limit the total number of data source providers. The incoming data can come from any source that a rule engine is able to access, including any of the devices in the computing system. This could include (but is not limited to) data from the following:
Security software (antivirus, whitelisting, etc.)
Data acquisition subsystems (SIEMs, SCOM, etc.)
Devices (routers, switches, etc.)
Computers (events, performance, etc.)
Data sources (including, but not limited to, databases and files)
Applications that inject data (such as for testing, simulation, etc.)
Web applications (Web API)

The data source providers 212 can be specific as to the device, software, or other input source from which they are getting data. Each can include custom code that knows how to get the data from an input source. The data can be passed to and processed by a normalization component 214 that takes the incoming data and formats it to a common format related to the type of data. For example, data from different antivirus software products can be grouped into similar data items, and the values can be formatted to common values (antivirus installed, antivirus enabled, etc.). This data is made available to the rule engine framework 240 and used by the end point rule sets 230.

The target data components 220 can be associated with and provide information generated by the rule engine framework 240 to various devices or systems. For example, the target data components 220 can be used to interact with mobile or fixed computing devices of personnel responsible for managing security in the system 100. Target data components 220 can include data source adapters 222 that convert the information generated by the rule engine framework 240, such as cyber security risk information, into a format that can be processed by the respective target data components 220. In general, inputs to rule engine framework 240 are from data source providers 212 and outputs from rule engine framework 240 are provided to target data components 220.

The end point rule sets 230 define different rules to be applied to data from the source data components 210. The rules in the end point rule sets 230 are used to analyze characteristics of different devices and different events that occur involving the devices (such as the various devices in FIG. 1). The rules can also generate values indicative of security vulnerabilities or other problems with the source data components 210. For example, the rules can be used to generate at least one risk assessment value identifying at least one cyber-security risk of the devices.

In various embodiments, the end point rule sets 230 get configuration data associated to the rules via values that are defined by the user. This allows a specific site implementation to modify the rules to fit their site needs if they desire. For example, a site might have different clusters or zones of devices where the devices in that zone are not critical to the plant operations or other functions. In this case, certain types of risks that would normally be ranked with a high value could be modified so that the values are not that high. This would prevent zones of little importance from overshadowing the other zones that might be more important. The end point rules sets 230 can include weighting factors or other user-definable configuration data as part of specific rules that are applied to increase or decrease the risk assessment value associated with any specific device or cyber-security risk.

The rule engine framework 240 is a primary component for the rule handling infrastructure 200. It handles start-up tasks for the rule engine, which could include:
Loading the end point rule sets 230;
Loading the source data components 210;
Loading the target data components 220;
Getting configuration items for each rule; and
Initializing data models.

A data model for devices can include a hierarchy tree that groups data based on how the data was configured when the system was set up. This allows for grouping risk items and assigning impact risks on other items within the hierarchy tree. Once the rule engine is initialized, it can start threads, such as to handle the processing of each independent source data component 210. The rule engine framework 240 also contains a common data adapter interop component, which identifies the internal data formats that are passed to individual components in the rule engine. This includes data internal to the rule engine framework 240 and data passed between data source providers, data source adapters, and end point rule sets.

The rule engine framework 240 also contains individual features for defining behaviors 242 on rules defined in the rule sets. This can include, but is not limited to, behaviors to support time-based rules, cumulative rules, and impact rules. Time-based behaviors allow for defining rules that have some special processing based on the passage of time. Cumulative-based behaviors allow for defining rules that have special processing on data based on how many times data of the rule is processed. Impact rules allow for defining a rule that impacts the risk on other devices in the hierarchy tree of the device that the rule is processing.

The rule engine framework 240 supports the ability to aggregate the risk items from risk areas, PCs, zones, and sites into one or more aggregate sets 244. Based on the rule set calculations, it can assign the highest risk found at a particular level and, for example, make it available to display, for example in GUI 250. For example, a zone aggregate record could display the highest risk item calculated among the PCs and devices found within the zone. The calculation of aggregates and aggregate sets 244 can be common among all rules so it is part of the rule engine framework 240 to make the end point rule sets 230 simpler and light weight (less complicated).

Rules engine framework includes an execution engine 246, that can be implemented using one or more processors or controllers, that executes the various processes as described herein. These can be executed under the control of executable instructions stored in a machine-readable medium.

Among other things, this infrastructure 200 can include a number of unique features. For example, in various embodiments, source data and target data components 210-220 can be added and removed as needed without requiring any changes to the rule engine framework 240 or the end point rule sets 230. In various embodiments, end point rule sets 230 can be added or removed without requiring any changes to the rule engine framework 240. In various embodiments, the rule engine framework 240 defines behaviors that can be applied to rule sets 230 that provide handling time-based rules, cumulative rules, impact rules, etc.

In some embodiments, end point rule sets 230 can be generic, and adding a new source data provider need not require the end point rule set 230 to be modified if a rule set already exists for that data source type (such as antivirus). In various embodiments, the rule engine framework 240 provides features to calculate aggregate risk assessment values, which can be aggregated from the bottom level (such as PC or device level, etc.) all the way up (zone, site, etc.). In various embodiments, data is broken up into individual items and identified as risk items. The risk items have individual risk factors applied to them, thereby allowing some risk items to be more critical than others.

In some embodiments, the rule engine also calculates risks (in addition to merely collecting data). In various embodiments, risk calculations can be based on the ISO 27005 risk management standard (ISO/IEC 27005:2011) or other standard.

Although FIG. 2 illustrates one example of a rule handling infrastructure 200 for identifying security issues in industrial process control and automation systems or other systems, various changes may be made to FIG. 2. For example, the functional division of the components 210-250 and the functional divisions within each component 210-250 are for illustration only. Various components or sub-components could be combined, further subdivided, rearranged, or omitted and additional components or sub-components could be added according to particular needs.

FIG. 3 illustrates a flowchart of a process 300 in accordance with disclosed embodiments, that can be performed, for example, by risk manager 154, rule handling infrastructure 200, or other device configured to perform as described, referred to generically as the “risk manager system” below.

The risk manager system receives information identifying characteristics of multiple devices in a computing system and multiple events associated with the multiple devices (305). In some embodiments, the information is received from source data components that are associated with and collect data from the multiple devices. In some embodiments, the information is processed by a normalization component that formats the information to a common format according the type of the information.

The risk manager system analyzes the information using multiple sets of rules (310). In some embodiments, the risk manager system also transmits cyber security risk information, corresponding to the analysis, to one or more target data components. In some embodiments, the risk manager system also converts cyber security risk information, corresponding to the analysis, into a format that can be processed by respective target data components. In some embodiments, the risk manager system also defines behaviors and applies the behaviors to the multiple sets of rules, the multiple sets of rules including at least one of time-based rules, cumulative rules, and impact rules.

The risk manager system generates at least one risk assessment value based on the analyzing, the at least one risk assessment value identifying at least one cyber-security risk of the multiple devices (315). In some embodiments, the risk manager system also aggregates risk assessment values over a hierarchy of the multiple devices.

The risk manager system stores and displays the at least one risk assessment value to a user (320).

Note that the risk manager 154 and/or the rule handling infrastructure 200 shown here could use or operate in conjunction with any combination or all of various features described in the following previously-filed and concurrently-filed patent applications (all of which are hereby incorporated by reference):

U.S. patent application Ser. No. 14/482,888 entitled “DYNAMIC QUANTIFICATION OF CYBER-SECURITY RISKS IN A CONTROL SYSTEM”;

U.S. Provisional Patent Application No. 62/036,920 entitled “ANALYZING CYBER-SECURITY RISKS IN AN INDUSTRIAL CONTROL ENVIRONMENT”;

U.S. Provisional Patent Application No. 62/113,221 entitled “NOTIFICATION SUBSYSTEM FOR GENERATING CONSOLIDATED, FILTERED, AND RELEVANT SECURITY RISK-BASED NOTIFICATIONS” and corresponding non-provisional U.S. patent application Ser. No. ______ of like title (Docket No. H0048937-0115) filed concurrently herewith;

U.S. Provisional Patent Application No. 62/113,100 entitled “TECHNIQUE FOR USING INFRASTRUCTURE MONITORING SOFTWARE TO COLLECT CYBER-SECURITY RISK DATA” and corresponding non-provisional U.S. patent application Ser. No. ______ of like title (Docket No. H0048943-0115) filed concurrently herewith;

U.S. Provisional Patent Application No. 62/113,186 entitled “INFRASTRUCTURE MONITORING TOOL FOR COLLECTING INDUSTRIAL PROCESS CONTROL AND AUTOMATION SYSTEM RISK DATA” and corresponding non-provisional U.S. patent application Ser. No. ______ of like title (Docket No. H0048945-0115) filed concurrently herewith;

U.S. Provisional Patent Application No. 62/113,165 entitled “PATCH MONITORING AND ANALYSIS” and corresponding non-provisional U.S. patent application Ser. No. ______ of like title (Docket No. H0048973-0115) filed concurrently herewith;

U.S. Provisional Patent Application No. 62/113,152 entitled “APPARATUS AND METHOD FOR AUTOMATIC HANDLING OF CYBER-SECURITY RISK EVENTS” and corresponding non-provisional U.S. patent application Ser. No. ______ of like title (Docket No. H0049067-0115) filed concurrently herewith;

U.S. Provisional Patent Application No. 62/114,928 entitled “APPARATUS AND METHOD FOR DYNAMIC CUSTOMIZATION OF CYBER-SECURITY RISK ITEM RULES” and corresponding non-provisional U.S. patent application Ser. No. ______ of like title (Docket No. H0049099-0115) filed concurrently herewith;

U.S. Provisional Patent Application No. 62/114,865 entitled “APPARATUS AND METHOD FOR PROVIDING POSSIBLE CAUSES, RECOMMENDED ACTIONS, AND POTENTIAL IMPACTS RELATED TO IDENTIFIED CYBER-SECURITY RISK ITEMS” and corresponding non-provisional U.S. patent application Ser. No. ______ of like title (Docket No. H0049103-0115) filed concurrently herewith;

U.S. Provisional Patent Application No. 62/114,937 entitled “APPARATUS AND METHOD FOR TYING CYBER-SECURITY RISK ANALYSIS TO COMMON RISK METHODOLOGIES AND RISK LEVELS” and corresponding non-provisional U.S. patent application Ser. No. ______ of like title (Docket No. H0049104-0115) filed concurrently herewith; and

U.S. Provisional Patent Application No. 62/116,245 entitled “RISK MANAGEMENT IN AN AIR-GAPPED ENVIRONMENT” and corresponding non-provisional U.S. patent application Ser. No. ______ of like title (Docket No. H0049081-0115) filed concurrently herewith.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving information identifying characteristics of multiple devices in a computing system and multiple events associated with the multiple devices;
analyzing the information using multiple sets of rules;
generating at least one risk assessment value based on the analyzing, the at least one risk assessment value identifying at least one cyber-security risk of the multiple devices; and
displaying the at least one risk assessment value in a user interface.

2. The method of claim 1, wherein the information is received from source data components that are associated with and collect data from the multiple devices.

3. The method of claim 1, wherein the information is processed by a normalization component that formats the information to a common format according to the type of the information.

4. The method of claim 1, further comprising transmitting cyber security risk information, corresponding to the analysis, to one or more target data components.

5. The method of claim 1, further comprising converting cyber security risk information, corresponding to the analysis, into a format that can be processed by respective target data components.

6. The method of claim 1, further comprising defining behaviors and applying the behaviors to the multiple sets of rules, the multiple sets of rules including at least one of time-based rules, cumulative rules, and impact rules.

7. The method of claim 1, further comprising aggregating risk assessment values over a hierarchy of the multiple devices, and wherein the risk assessment values are weighted according to user-definable configuration data.

8. A risk manager system comprising:
a controller; and
a display, the risk manager system configured to
receive information identifying characteristics of multiple devices in a computing system and multiple events associated with the multiple devices;
analyze the information using multiple sets of rules;
generate at least one risk assessment value based on the analyzing, the at least one risk assessment value identifying at least one cyber-security risk of the multiple devices; and
display the at least one risk assessment value in a user interface.

9. The risk manager system of claim 8, wherein the information is received from source data components that are associated with and collect data from the multiple devices.

10. The risk manager system of claim 8, wherein the information is processed by a normalization component that formats the information to a common format according to the type of the information.

11. The risk manager system of claim 8, wherein the risk manager system also transmits cyber security risk information, corresponding to the analysis, to one or more target data components.

12. The risk manager system of claim 8, wherein the risk manager system also converts cyber security risk information, corresponding to the analysis, into a format that can be processed by respective target data components.

13. The risk manager system of claim 8, wherein the risk manager system also defines behaviors and applies the behaviors to the multiple sets of rules, the multiple sets of rules including at least one of time-based rules, cumulative rules, and impact rules.

14. The risk manager system of claim 8, wherein the risk manager system also aggregates risk assessment values over a hierarchy of the multiple devices, and wherein the risk assessment values are weighted according to user-definable configuration data.

15. A non-transitory machine-readable medium encoded with executable instructions that, when executed, cause one or more processors of a risk manager system to:
receive information identifying characteristics of multiple devices in a computing system and multiple events associated with the multiple devices;
analyze the information using multiple sets of rules;
generate at least one risk assessment value based on the analyzing, the at least one risk assessment value identifying at least one cyber-security risk of the multiple devices; and
display the at least one risk assessment value in a user interface.

16. The non-transitory machine-readable medium of claim 15, wherein the information is received from source data components that are associated with and collect data from the multiple devices.

17. The non-transitory machine-readable medium of claim 15, wherein the information is processed by a normalization component that formats the information to a common format according to the type of the information.

18. The non-transitory machine-readable medium of claim 15, wherein the risk manager system also transmits cyber security risk information, corresponding to the analysis, to one or more target data components.

19. The non-transitory machine-readable medium of claim 15, wherein the risk manager system also converts cyber security risk information, corresponding to the analysis, into a format that can be processed by respective target data components.

20. The non-transitory machine-readable medium of claim 15, wherein the risk manager system also defines behaviors and applies the behaviors to the multiple sets of rules, the multiple sets of rules including at least one of time-based rules, cumulative rules, and impact rules.
